(19) United States
(12) Patent Application Publication
(10) Pub. No.: US 2012/0059513 A1
(43) Pub. Date: Mar. 8, 2012

(54) BEVERAGE DISPENSING AND MONITORING SYSTEM

(76) Inventors: Shannon Perkins, Denver, CO (US); Jonathan Ross, Denver, CO (US); Joseph Calkins, Florence, KY (US)

(21) Appl. No.: 13/225,427

(22) Filed: Sep. 3, 2011

Related U.S. Application Data
(60) Provisional application No. 61/402,639, filed on Sep. 3, 2010.

(51) Int. Cl. G06F 17/00; B67D 7/06

(52) U.S. Cl. 700/244; 222/23; 700/231; 700/236; 700/237

(57) ABSTRACT

A system for dispensing beverages includes a container coupler having a sensor box with a fluid flow sensor, and a tag reader for reading identification tags mounted on a container. The container coupler has a handle for selectively actuating the container coupler to attach and remove the container coupler from a container. The container coupler has a gas inlet for pressurizing a container, and a fluid outlet for delivering fluid to a dispenser. The sensor box is affixed to the fluid outlet, or integrated with the container coupler, to enable the fluid flow sensor to measure fluid flow volumes, rates, or both. The tag reader is affixed on the sensor box of the container coupler for reading identification tags from a keg. An advantage of having a sensor box on the container coupler is that the sensor box is held during use in close proximity to any tags affixed to the container.

### PRIORITY CLAIM

This patent application claims priority to U.S. Provisional Patent Application Ser. No. 61/402,639, filed on Sep. 3, 2010.

### FIELD OF THE INVENTION

This invention relates to systems that dispense fluids, and in particular devices and systems for dispensing and monitoring beverages dispensed from a container, such as a beer keg.

### BACKGROUND OF THE INVENTION

U.S. Pat. No. 7,779,099 to Raghunathan et al. describes a distributed flow meter network associated with the distribution of draft beverages at point of sale (POS) locations. The network gathers fluid meter data and fluid attributes and communicates the data to a network. The system seeks to improve efficiency and control of beverage distribution. While the Raghunathan et al. invention marks progress in the art of monitoring of beverage distribution, there is little provision for improving the resilience and durability of the system.

Containers are rolled dropped and bumped when they are moved, and particularly when they are tapped. This is due to the weight and bulk of most containers. Containers are also difficult to move and properly position when tapped.

Traditionally, fluid meter systems have been installed on the conduits that deliver beverages to a tap. This method of mounting a fluid meter in-line with a conduit is practical for obtaining measurements of fluid flow. However, additional data is typically required that matches the fluid in the conduit with a particular container so that they system is made aware of the type of beverage dispensed.

Optimally the fluid flow meter system also has a tag reader component that reads bar codes or RFID tags. These tags store data such as beverage type, manufacturer, lot number, date of manufacture and other data particular to a container. In some systems, the tag reader is hand held. This can become cumbersome. What is desired is a system that does not require a hand-held tag reader.

Mounting an automated tag reader in a system has been a challenge because tags mounted on top of a container are not always easily read by a fixed device. The rim of the container, the mouth, the coupler and regulator may interfere with a reader. Further the orientation of the container may need to be adjusted to obtain a satisfactory read. Metal containers may interfere with electromagnetic signals. Since containers are heavy, few want to move them unnecessarily. What is desired is a way of mounting a tag reader in a beverage distribution system that assures maximum reader performance. What is also desired is a way of mounting a tag reader that assures reliability of the tag reader. What is further desired is a way of mounting a tag reader that assures that the tag reader will not break or malfunction when a container is moved.

### SUMMARY OF THE INVENTION

A beverage dispensing and monitoring system includes a coupler connectable with a container for enabling fluid flow from the container. The system includes a fluid coupling removeably attachable in fluid communication with the coupler. A sensor box attaches in operative engagement with the fluid coupling to sense fluid attributes, the sensor box includes a microcontroller, a tag reader and a transmitter. The transmitter interconnects the sensor box with a server via a network to enable the server to compile and re-distribute data reflective of the fluid attributes.

In one embodiment of the invention, the fluid coupling is a quick connect coupling having a spring loaded sleeve and a ring of bearings to facilitate quick connections and disconnection of the keg coupler and the sensor box. Quick connect couplings offer the advantage of enabling easy and rapid removal and re-installation of the sensor box on the container coupler. This is particularly important when the container is in a hard-to reach or confined space such, where the container is a beer keg, or other beverage keg, and where the container coupler is a keg coupler.

In another embodiment, the fluid coupling includes a sleeve and swivel nut, the swivel nut enables the sensor box to swivel with respect to the coupler. One advantage of a swiveling connection between the sensor box and the coupler is that it enables the coupler to rotate to tap a container without requiring the sensor box to also rotate. Another advantage of the swiveling connection is that beverage lines or conduits that are twisted will not unduly interfere with the process of tapping a container.

In an alternate embodiment of the invention, the wherein the fluid coupling includes a bracket and the coupler includes a fluid line and a gas line. The bracket mounts on the fluid line and the gas line of the coupler. The sensor box is connectable to the bracket to enable the bracket to firmly support the sensor box. The bracket has an advantage of enabling the sensor box to connect to both the fluid line and the gas line to improve resilience and durability of the sensor box, and to inhibit relative movement between the sensor box and the coupler.

The sensor box may be cylindrical in shape, or may comprise a curved enclosure having one end with a periphery defining an opening, the periphery slides over the coupling to hold the sensor system on the fluid coupling of the coupler.

In an alternate embodiment, the sensor box includes a shroud that holds the sensor box. The shroud has an open end, the open end is sized to slide over and surround a portion of the keg coupler. The open end of the shroud is sized to enable a press fit over a container mouth. The shroud protects the sensor box from movement and damage.

Preferably, the tag reader includes an RFID tag reader for reading RFID tags affixed to a container. The tag reader, in another embodiment, includes a bar code scanner for reading bar codes affixed to a container. In yet another embodiment, the tag reader includes a bar code scanner and an electromagnetic tag reader. Electromagnetic tag readers include E&M readers, NFZC devices, CCD devices, or traditional RFID tag reader.

Data collected from the system is distributed to a network and utilized. In particular, the transmitter communicates cellular or other wireless signals to the network. This enables network users to track relevant product consumption, quality and character in real time.

### DESCRIPTION OF THE DRAWINGS

FIG. 1 is a perspective view of the system of the present invention.

FIG. 2 is a perspective view sensor box fluid connection with a keg coupler.

FIG. 3 is a perspective view of the keg coupler with a swivel.

FIG. 4 is a perspective view of a keg coupler having bracket holding the sensor box on a fluid line and a gas line.

FIG. 5 is a perspective view of a keg coupler having swivel.

FIG. 6A is a top view of an embodiment of the sensor box.

FIG. 6B is a side view of a sensor box mounted on a fluid conduit.

FIG. 6C is a perspective view sensor box.

FIG. 7 is a system diagram in accordance with the present invention.

### DETAILED DESCRIPTION

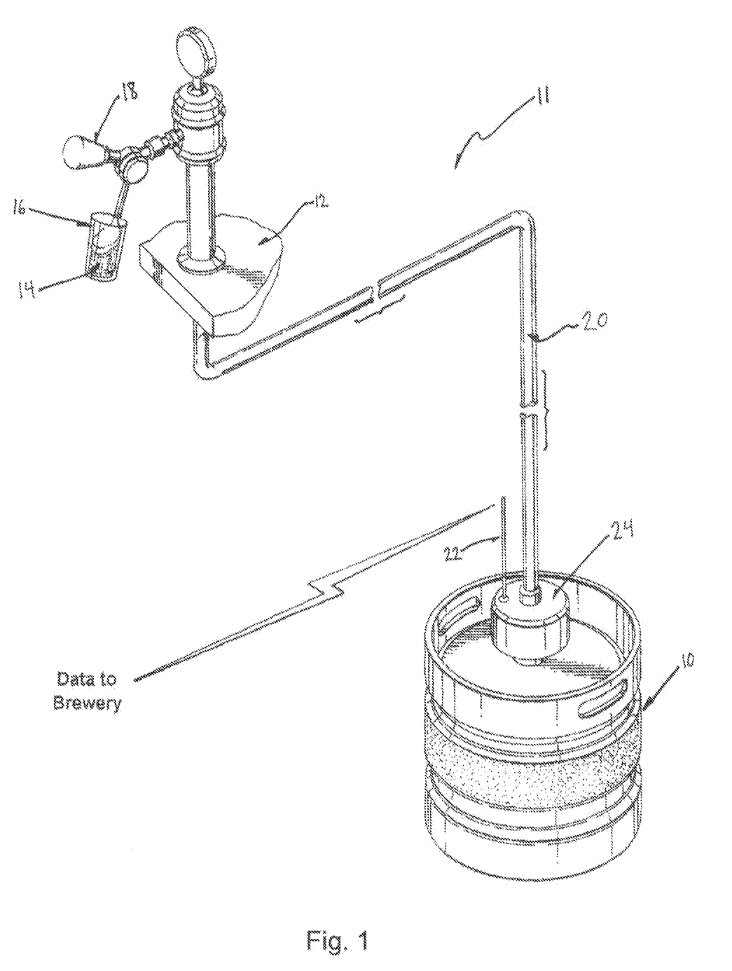

FIG. 1 shows a system 11 for delivering and monitoring fluid from a container to a dispenser. The system includes a beverage container 10, a conduit 20, a beverage dispenser 18, a beverage glass 16, and a sensor box 24. The sensor box 24 includes a transmitter 22 for delivering data characteristic of the beverage to a network which may include manufacturers, distributors, point-of-sale vendors and others.

The dispenser 18 includes a tap that mounts on the bar 12 and is actuated to poor a beverage such as beer 14 into the patron's glass 16. The conduit 20 interconnects the dispenser 18 with the container 10. The sensor box 24 mounts in fluid communication with the beverage conduit 20. In one embodiment the sensor box 24 mounts on the mouth of the container 10. In another embodiment sensor box 24 mounts on the fluid conduit 20. In yet another embodiment the sensor box 24 mounts on a coupler that is removeably affixed to the container 10.

The sensor box 24 measures attributes of the beverage 14. The attributes include flow rate or total flow, temperature, pressure and any other attributes of the beverage that are useful in determining quality. The sensor box 24 is also equipped with a tag reader for reading barcodes, RFID tags or other forms of tags on the container.

One purpose of the system 11 having a sensor box mounted or embedded to a container coupler (or outlet) is to is to optimize supply chain management, including quality control, and just-in-time delivery. Another purpose of the system 11 is to enable the gathering of Point-of-sale (POS) or Point-of-Use (POU) data. Such POS or POU data is relayed by the transmitter 22 to a network where it is available to supply chain participants. Specifically within the Beverage Industry Supply Chain, this would allow Manufacturers and Distributors to manage their Brands across Dispensing locations, assets, and react more quickly to quality control issues. Other information may be generated for the Retailer POS or POU location. By the Device identifying a product and sharing that information, the data can also be made available for any party, such as Consumers of Beverages.

### The Sensor Box

The sensor box 24 comprises a microcontroller and memory on a system board. The sensor box 24 also includes a tag reader. The tag reader reads data via a Radio Frequency Identification (RFID) Tag, or from a bar code. The bar code, in one embodiment, is a data matrix bar code. The tag reader may be equipped with an electromagnetic identification reader sub-system or biologics identification reader. The reader, in one embodiment, includes the capability to write data to identification tags.

Sensors in the sensor box 24 include, but are not limited to, a Flowmeter, a Temperature Sensor, a Pressure Sensor, a Humidity Sensor, a Bioflavonoids Sensor, a Gas/Liquid substance Sensor. The sensor box 24 includes a power system having any combination of: a battery, an electrical plug, or other power source.

In one embodiment the sensor box 24 includes a micro turbine in-line, that generates power from fluid flow. The micro turbine can generate power from a gas line or fluid (i.e. beverage line) In another embodiment, a solar panel generates power for the system. The sensor box includes a LED Display, and one or more Communications Modules (Wireless transceiver, UART, USB, Digital).

### Sensor Box Components

The Microcontroller unit and/or Power Module provide power to all components within the Device. The Microcontroller contains software that interprets and controls the components within the Device. The Microcontroller continuously asks/listens to the Reader component for identification information, the Microcontroller may also occasionally ask/listen, depending upon the Microcontroller software. The Reader itself continuously searches (listening, pings, scans) for identification information to interpret and transmit to the Microcontroller. The Reader itself may also occasionally search for identification information, depending upon its internal logic or Microcontroller software.

The Microcontroller interacts with other Sensors. In the case of Temperature sensors, the Microcontroller interprets voltages and calculates the temperature based on mathematical equations, such as the Stein-Hart Equation. In the case of a, or many, Flowmeters, the Microcontroller interprets pulses, or voltages/current, and then calculates the amount of flow based on software logic. The Microcontroller can also manage the behavior and interaction of the Power System, LED display and Communications Modules.

Any information collected by the Microcontroller, and depending upon software, may be stored in memory and/or sent to the Communications Module from which it is transmitted to another Device, a Computer, Server, or data receiver. Any information collected by the Microcontroller that is captured in memory may be transmitted at a later time. Additionally, the LED display may present data captured by the Device driven by the Microcontroller.

In one embodiment the sensor box 24 is integrated with the coupler. In one variation the sensor box mounts on the coupler and in another embodiment, the sensor box is embedded within the coupler. This achieves the goal of having a reader affixed in close proximity with ID tags mounted on top of the container 10.

### Transmitter

In one embodiment the transmitter is networked wirelessly to communicate with a wireless or cellular network. The transmitter also includes a near-field antenna for reading an RFID tag affixed to the top of the container 10. The antenna extends from the sensor box 24. The antenna includes a conductive wire such as copper wrapped in a number of loops. The character of the wire i.e. t thickness, r resistance, v voltage, i current, L inductance, to create an electro-magnetic field to attenuate a tag, of sufficient coverage determined by the method of use. This antenna will be placed to have a predetermined reading angle to assure effectiveness in reading, and in some cases, writing to a tag.

In another alternate embodiment the antenna is internally affixed within the sensor box 24. In yet another alternate embodiment, an antenna is not necessary, particularly where the reader is a NFC, IR or similar device that will have a viewing angle and distance sufficient to interpret/communicate with non electro-magnetic tag. This viewing angle will create the ability to read tags mounted on top of the container including the rim of the container. Accordingly, it is an advantage of the invention to enable positioning of a sensor box in close proximity with the top of a container, where the sensor box also communicates with a wireless network, and where the sensor box directly senses fluid attributes. Since many containers are made from metal, which can interfere with an RFID signal, placing the reader in a position affixed to the top of the container minimizes interference caused by the container.

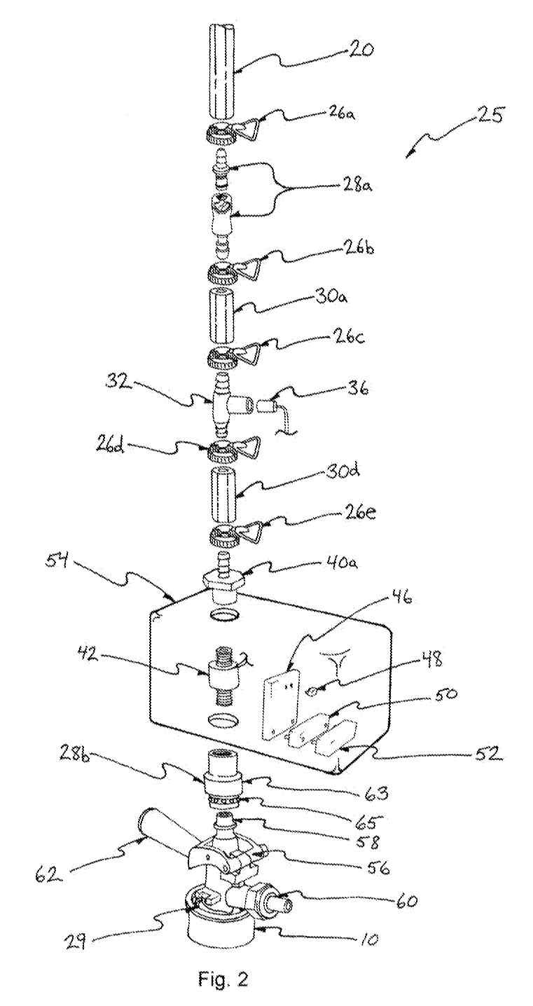

FIG. 2 shows a system 25 for mounting a sensor box 54 in fluid communication with a beverage container such as the keg 10. The container has a mouth 29.

The system 25 includes a coupler 56 having a handle 62, a gas inlet 60 and a fluid outlet 58. The system 25 includes a fluid conduit 20, sections of fluid conduit 30a, 30b, 30c, and 30d, hose clamps 26a, 26b, 26c, 26d, a threaded barbed connector 40a, and two quick connect couplings 28a and 28b that cooperate to connect in fluid communication the fluid conduit 20 with the sections of fluid conduit 30a, 30b, 30c, and 30d, and the coupler 56 via the sensor box 54. The coupler 56 has an outlet 58 having a male quick connect coupling adapter, which removeably connects to the quick connect coupling 28b.

The sensor box 54 has an inlet side in fluid communication with the container coupler 56 and an outlet side in fluid communication with the conduit 20. The quick connect coupling 28a mounts on the conduit 20 in-line on the outlet side of the sensor box 54. The quick connect coupling 28b mounts between the inlet side of the sensor box 54 and the container coupler 56.

The system 25 includes a T-connector 32 connected in-line with the conduit 30a. The T-connector 32 includes an opening for receiving an in-line temperature sensor 36. The temperature sensor 36 positioned distant from, and electrically communicates with the sensor box 54. Positioning the temperature sensor 36 distant from the sensor box to enable the temperature sensor to sense fluid temperature closer to the dispenser (FIG. 1). In some systems, however, the temperature sensor 36 may be integrated into the sensor box 54.

The system 25 includes a flow meter 42 and the barbed threaded connector 40a for threadibly connecting to the flow meter 42 within the sensor box 54 and press-fitting the flow meter 42 to the conduit 30d. Ideally the flow meter 42 is affixed within the sensor box 54 to protect the flow meter 42 from damage and to assure an undisturbed connection between the flow meter and the other internally-housed electrical components.

The sensor box 54 internally-houses the flow meter 42, a microcontroller 46, a temperature sensor 48 for detecting ambient air temperature, a tag reader 50 and a transmitter 52. These components within the sensor box 54 are in operative communication with each other and with the temperature sensor 36.

The container coupler 56 includes a fluid outlet 58 comprising a quick connect coupling adapter and a container coupler gas inlet 60 for receiving a gas line for receiving carbon dioxide gas or nitrogen gas, or a hybrid gas mixture.

The quick connect coupling 28b includes a sliding sleeve 63, and an annularly aligned set of ball bearings 65. The bearings 65 enable ease of connection of the coupling 28b to the fluid outlet 58 of the container coupler 56. The sliding sleeve 63 selectively locks the coupling 28b to the fluid outlet 38.

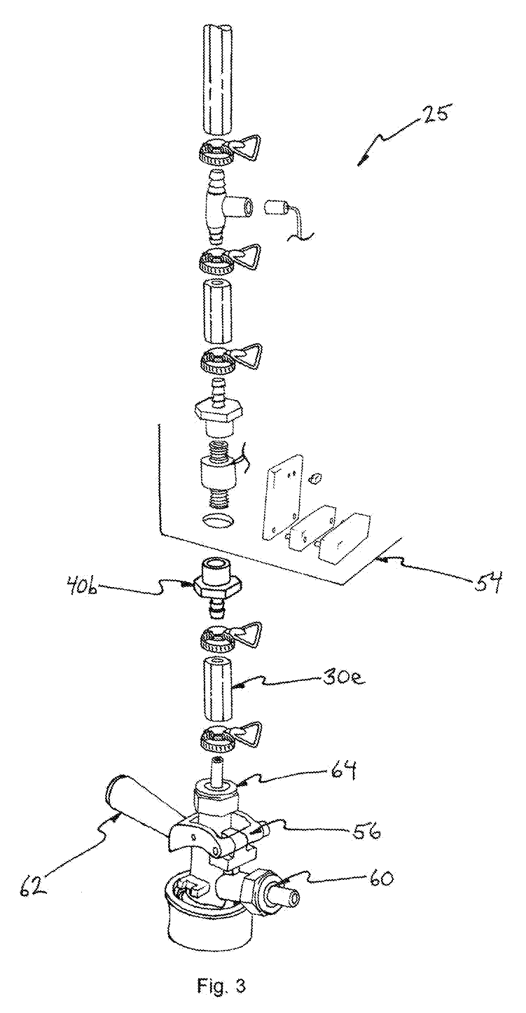

FIG. 3 shows an embodiment the system 25. The inlet side of the sensor box 54 attaches in fluid communication with the barbed threaded connector 40b. The container coupler 56 includes a swivel nut connector 64 that connects to the barbed threaded connector 40b via the conduit 30e. The swivel nut connector 64 includes a spout and a nut. The nut holds the spout in proximity to the keg coupler 56 and enables the conduit 30 to rotate with respect to the container coupler 56. An advantage of a swivel connection is that it enables the container coupler to easily twist during connecting and disconnecting of containers without unnecessarily rotating the sensor box 54.

Container connecting and disconnecting may be difficult when the conduit 30, for example, is twisted. The swivel nut connector 64 establishes a swiveling connection to minimize twisting of the conduit 30e. A direct benefit of the swivel connection is that the sensor box 54 is unlikely to be damaged when the container is connected, disconnected, or moved while connected to the system 25. Further the likelihood of leakage of fluid within the sensor box 54 is minimized by employing swiveling fluid connections outside of the sensor box 54, either on the inlet side or the outlet side, or both.

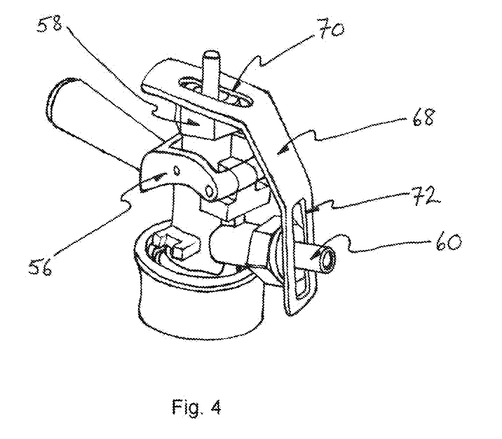

FIG. 4 shows the container coupler 56 having the container coupler inlet 60 and the container coupler outlet 58 and attached bracket 68. The bracket 68 defines an opening 70 an opening 72, which mount over the fluid outlet 58 and the gas inlet 60, respectively. The fluid outlet 58 and the gas fluid outlet 58 and the gas and 60 firmly hold the bracket 68. The bracket 68 catches sensor box 54 (FIG. 2) to the keg coupler 56.

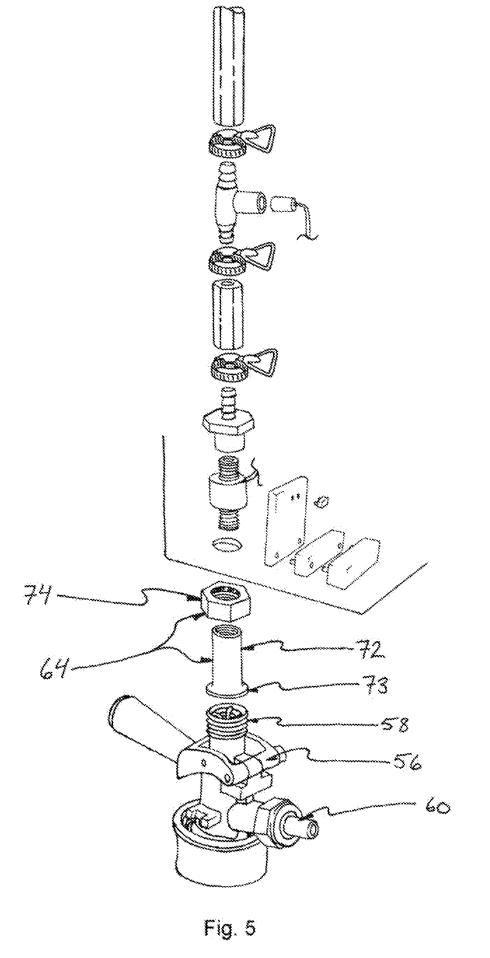

FIG. 5 shows the container coupler 56 having an outlet 58 with the swivel nut connector 64. The swivel nut connector 64 includes a swivel nut 74 and a spout 72. The spout 72 is adapted to swivel with respect to the outlet 58. The outlet 58 is threaded to establish a threaded engagement with the swivel not 74. The spout 72 has a flange 73 which seats on the outlet 58 to create a fluid seal that also allows swiveling motion.

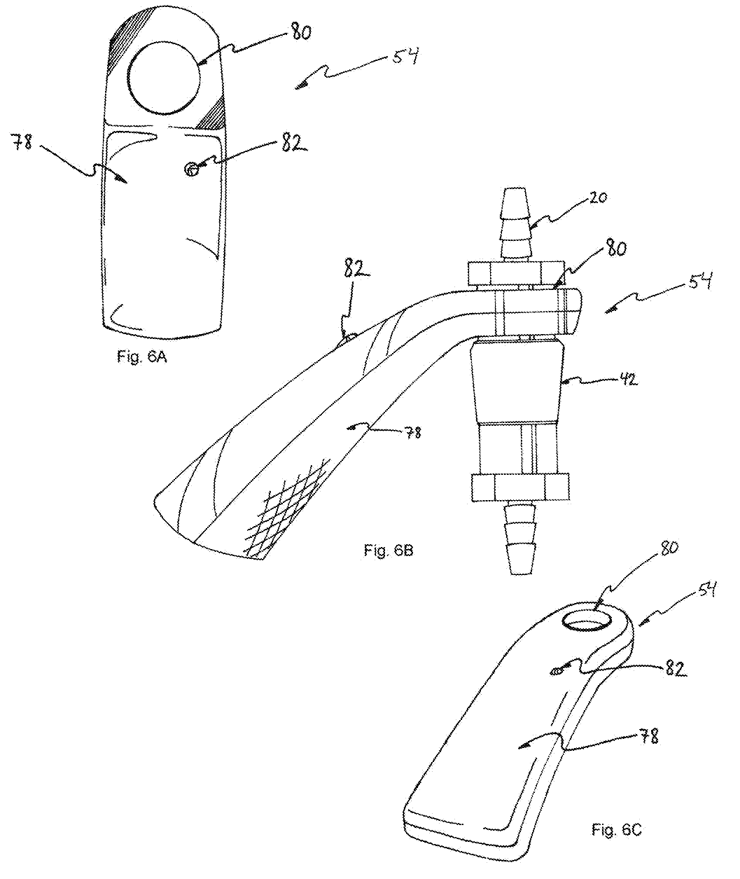

FIGS. 6A-6C show an embodiment of the sensor box 54. The sensor box 54 has an outer surface 78 including a LED indicator 82 that illuminated when the sensor box 54 operates. The sensor box 54 defines opening 84 positioning the sensor box 54 around a fluid conduit. The sensor box opening 84 has an annular shaped to enable rotation of the sensor box with respect to the conduit. Accordingly, in operation, the sensor box 54 rotates freely with respect to the conduit to optimally align sensor box with tags to be read. Rotation of the sensor box also enables ease in connecting and disconnecting when the container coupler 56 attaches in line with the conduit 20. Rotation of the sensor box 54 protects the sensor box and its components from impact that could easily occur such as when a container is moved or connected.

FIG. 6B shows the flow meter 42 attached on the conduit near the inlet side of the sensor box 54. The flow meter 42 communicates electronically with the sensor box 5 to communicate fluid flow information to the sensor box 54.

FIG. 6C shows a perspective view of the sensor box 54. The surface 78 curves from the opening 80 towards top of the container when mounted on top of the container.

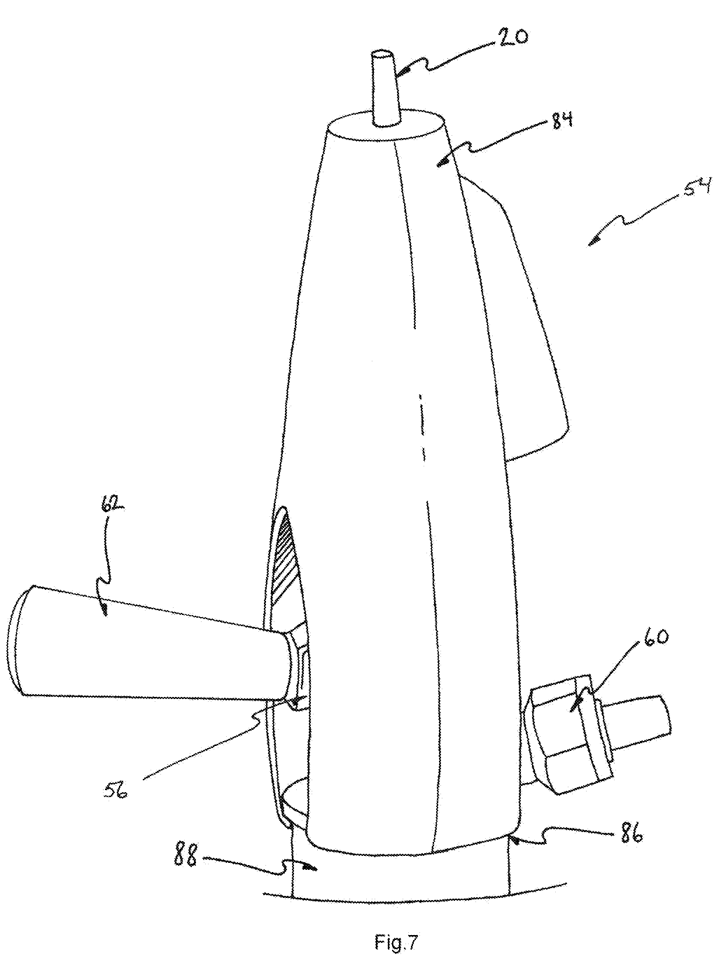

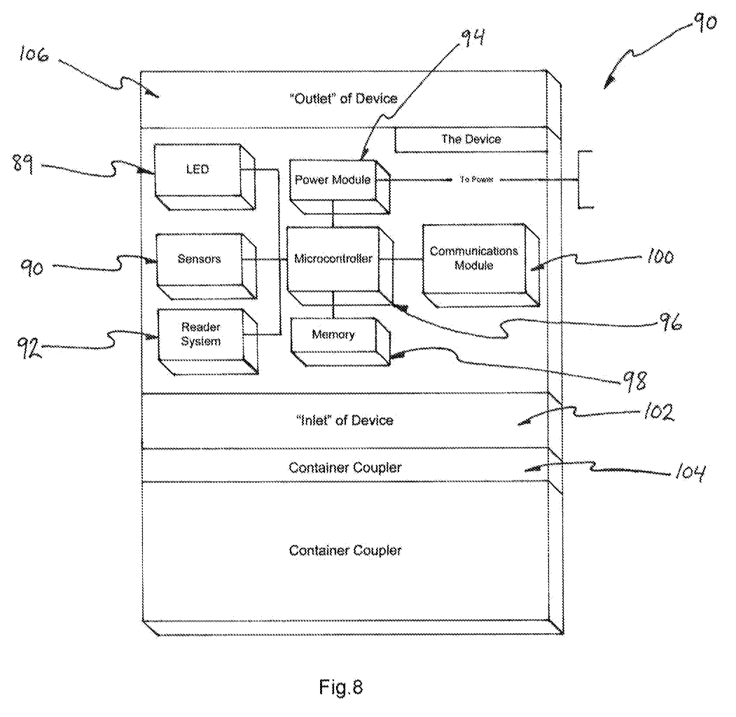

FIG. 7 shows sensor box 54 mounted on the conduit 20 and on the keg coupler 56. The sensor box 54 of the shroud 84 surrounding the sensor box 54 and a portion of the container coupler 56. The shroud 84 has an open end 86 press-fit onto the mouth 88 of a container. The shroud protects the sensor box 54 and allows rotation of the sensor box 54 when the container coupler 56 rotates with respect to the container during connecting and disconnecting of the container.

FIG. 7 shows a fluid dispensing and monitoring system 90 including an inlet 102 and an outlet 106. The inlet is integral with a container coupler 104. The outlet 106 is in fluid communication with a dispenser, such as a beer tap. The system 90 includes LED indicator 88, sensors 90, a reader system 92, a power module 94, a microcontroller 96, memory 98, and a communications module 100.

The LED indicator 89 includes a lamp to indicate system operation, and may include an LED screen with alpha-numeric indications of system performance and operation. The sensors include at least a flow meter and a temperature sensor, but may include any other sensor depending on the type of fluid dispensed. The reader system 92 preferably includes any of a variety of electro-magnetic sensors, or optical sensors. The microcontroller 96 communicates with the memory 98 to enable the memory to buffer and communicate instructions to the microcontroller 96. The communications module 100 includes a transmitter, which can send and receive signals via a network or wireless connection. The transmitter includes an antenna in an embodiment of the invention.

While the present invention is described in terms of various exemplary embodiments, it should be understood that numerous variants of the invention are contemplated. For example the container coupler can have an integrated tag reader. The tag reader can also both read and write to appropriate tags, such as RFID tags and other writable tags. The antennae can be particularly adapted to minimize interference where the container is a metal beer keg. The true scope of the invention is defined by the appended claims.

We claim:

1. A fluid monitoring system comprising:
a container coupler connectable with a container for enabling fluid flow from the container;
a fluid coupling removeably attachable in fluid communication with the container coupler;
a sensor box attached in operative engagement with the fluid coupling to sense fluid attributes, the sensor box includes a microcontroller, a tag reader and a transmitter;
the transmitter interconnects the sensor box with a server via a network to enable the server to compile and re-distribute data reflective of the fluid attributes.

2. A system as set forth in claim 1, wherein the fluid coupling is a quick connect coupling having a spring loaded sleeve and a ring of bearings to facilitate quick connections and disconnection of the keg coupler and the sensor box.

3. A as set forth in claim 1, wherein the fluid coupling includes a sleeve and swivel nut, the swivel nut enables the sensor box to swivel with respect to the container coupler.

4. A system as set forth in claim 1, wherein the fluid coupling includes a bracket, the container coupler includes a fluid line and a gas line, the bracket mounts on the fluid line and the gas line, the sensor box is connectable to the bracket to enable the bracket to firmly support the sensor box.

5. A system as set forth in claim 1, wherein the sensor box includes a curved enclosure having one end with a periphery defining an opening, the periphery slides over the coupling to hold the sensor system on the coupling.

6. A system as set forth in claim 1, wherein the sensor box includes a shroud having an open end, the open end is sized to surround a portion of the container coupler and is sized to enable the open end to press fit over a container mouth.

7. A beer dispensing system and monitoring system comprising:
a beer keg;
a dispenser for dispensing beer;
a conduit in fluid communication with the dispenser;
a first fluid coupling attached to the conduit, the first fluid coupling being a quick-connect coupling;
a sensor box attached to the first fluid coupling, the sensor box including a first temperature sensor to measure beer temperature, a fluid flow meter, a microcontroller in communication with the first temperature sensor and the fluid flow meter, a transmitter in communication with the microcontroller for transmitting data, and a tag reader for reading identification tags;
a second fluid coupling attached in fluid communication with the sensor box, the second fluid coupling being a quick-connect coupling;
a container coupler removeably connectable with the beer keg and with the second fluid coupling for enabling beverage to flow from the container through the sensor box and to the dispenser.

8. A beer dispensing system as set forth in claim 7, wherein tag reader includes an RFID tag reader for reading RFID tags affixed to a container.

9. A beer dispensing system as set forth in claim 7, wherein the tag reader includes a bar code scanner for reading bar codes affixed to a container.

10. A beer dispensing system as set forth in claim 7, wherein the tag reader includes a bar code scanner and a RFID tag reader.

11. A beer dispensing system as set forth in claim 7, wherein the transmitter communicates cellular signals to a network.

12. A beer dispensing system as set forth in claim 7, wherein the sensor includes a second temperature sensor for measuring ambient air temperature.

13. A container coupler for reading identification tags from a container comprising:
a handle for actuating the container coupler;
a gas inlet for pressurizing a container;
a fluid outlet for delivering fluid to a dispenser;
a sensor box affixed to the fluid outlet for sensing fluid attributes including fluid temperature and fluid flow characteristics; and
a tag reader affixed in the sensor box for reading identification tags from a container.

14. A container coupler as set forth in claim 12, wherein the fluid outlet includes a quick-connect coupling for removeably coupling the sensor box to the fluid outlet.

15. A container coupler as set forth in claim 12 further comprising a swivel to enable the sensor box to swivel with respect to the fluid outlet.

16. A container coupler as set forth in claim 12, wherein the sensor box has a periphery defining an opening, the opening mounts on the fluid outlet and enables the sensor box to swivel with respect to the fluid outlet.

17. A container coupler as set forth in claim 12, wherein the sensor box is rigidly affixed to the fluid outlet.

18. A container coupler as set forth in claim 12, wherein the sensor box is integral with the fluid outlet.

19. A container coupler as set forth in claim 12, wherein the sensor box includes a first temperature sensor in communication with the sensor box for measuring ambient air temperature.

20. A container coupler as set forth in claim 18, wherein the sensor box includes a second temperature sensor in communication with the sensor box for measuring fluid temperature.
